(19) United States
(12) Patent Application Publication
(10) Pub. No.: US 2005/0066674 A1
(43) Pub. Date: Mar. 31, 2005

(54) Refrigeration cycle

(75) Inventors: Hisatoshi Hirota, Tokyo (JP); Shinji Saeki, Tokyo (JP); Takeyasu Nishiyama, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TGK CO., LTD., Tokyo (JP)

(21) Appl. No.: 10/942,124

(22) Filed: Sep. 16, 2004

(30) Foreign Application Priority Data
Sep. 25, 2003 (JP) 2003-332651

(51) Int. Cl. G05D 23/02; F25B 41/00; F25B 49/00; F25B 41/04; F25B 41/06

(52) U.S. Cl. 62/222; 62/527; 236/101 R

(57) ABSTRACT

To provide a refrigeration cycle which is capable of reducing power consumption while solving the problems of hunting and oil circulation. The refrigeration cycle is formed by combining an expansion valve that controls the flow rate of refrigerant supplied to an evaporator such that refrigerant at the outlet of the evaporator always maintains a predetermined level of superheat, in normal times, and is equipped with a minimum flow rate-securing device capable of allowing the refrigerant to flow at a predetermined minimum flow rate when the flow rate is most restricted, with a variable displacement compressor.

### CROSS-REFERENCES TO RELATED APPLICATIONS, IF ANY

This application claims priority of Japanese Application No.2003-332651 filed on Sep. 25, 2003 and entitled “REFRIGERATION CYCLE”.

### BACKGROUND OF THE INVENTION

(1) Field of the Invention

The present invention relates to a refrigeration cycle, and more particularly to a refrigeration cycle using a variable displacement compressor for an automotive air conditioning system.

(2) Description of the Related Art

Conventionally, in an automotive air conditioning system, a variable displacement compressor is employed which is capable of continuously changing the volume of refrigerant discharged from the compressor, i.e. the displacement of the compressor such that the flow rate of refrigerant flowing through the refrigeration cycle is held at a predetermined value dependent on the cooling load, irrespective of changes in the rotational speed of the associated engine.

Known variable displacement compressors include a swash plate type which has a swash plate disposed in a hermetically closed crankcase and fitted on a rotating shaft receiving a driving force from an engine such that the inclination angle of the swash plate is variable, and changes the inclination angle of the swash plate by controlling the pressure in the crankcase, whereby the amount of stroke of pistons connected to the swash plate is changed to change the volume of the refrigerant discharged from the compressor.

The pressure in the crankcase is controlled by a capacity control valve that controls pressure introduced from a discharge chamber into the crankcase. Known capacity control valves include a Ps control type that senses suction pressure Ps of the variable displacement compressor and controls the pressure in the crankcase such that the suction pressure Ps is held constant, a Pd-Ps control type that senses differential pressure between discharge pressure Pd and suction pressure Ps of the variable displacement compressor and controls the pressure in the crankcase such that the differential pressure is held constant, and a flow rate control type that senses a discharge flow rate of the variable displacement compressor and controls the pressure in the crankcase such that the discharge flow rate is held constant.

A refrigeration cycle incorporating such a variable displacement compressor described above employs a thermostatic expansion valve or a solenoid-controlled electronic expansion valve. The thermostatic expansion valve performs throttling of high-temperature, high-pressure liquid refrigerant to change the same into low-temperature, low-pressure refrigerant within the refrigeration cycle, and controls the flow rate of refrigerant supplied to an evaporator, such that refrigerant vapor at the outlet of the evaporator maintains a predetermined level of superheat.

FIG. 6 is a diagram showing characteristics of thermostatic expansion valves, and FIG. 7 is a diagram showing changes in the power of a variable displacement compressor depicted in association with changes in cooling power. As the thermostatic expansion valve, there are conventionally known a cross-charged type that has characteristics represented by a curve A in FIG. 6, and a normally-charged (or parallelly-charged) type that has characteristics represented by a curve B. The cross-charged type thermostatic expansion valve is configured such that the temperature-pressure characteristic in a temperature-sensing tube has a gentler gradient than that of a saturated vapor pressure curve of refrigerant used in the refrigeration cycle. When the cross-charged type thermostatic expansion valve is employed, during low load operation in which the temperature of refrigerant at an outlet of the evaporator is low, the pressure in the temperature-sensing tube is higher than the saturated vapor curve, so that the expansion valve is continuously held open without responding to the pressure at the evaporator outlet.

Therefore, within one system of the refrigeration cycle, the flow rate control is carried out at two locations, i.e. at the variable displacement compressor and at the thermostatic expansion valve. For example, in the case of the Ps control-type variable displacement compressor, the compressor controls suction pressure Ps, which is approximately equal to the pressure at the evaporator outlet, such that the suction pressure Ps is held constant in a variable displacement region. On the other hand, due to the incapability of providing substantial control during low-load and low-flow rate operation of the system, the expansion valve is prevented from responding sensitively to the pressure at the evaporator outlet and hence from causing contention with the control of the variable displacement compressor, so that stable control without hunting can be achieved.

Further, since the cross-charged type thermostatic expansion valve continues to be open during low-load operation, the refrigerant at the evaporator outlet is returned to the variable displacement compressor, in a state not completely evaporated but containing some liquid. As a result, lubricating oil for the variable displacement compressor, which is dissolved in the liquid, is also returned to the variable displacement compressor, so that sufficient oil circulation is maintained even when the flow rate of refrigerant is low due to small displacement of the compressor when load thereon is small, which prevents seizure of the compressor due to shortage of lubricating oil.

On the other hand, the normally-charged type thermostatic expansion valve controls the flow rate of refrigerant supplied to the evaporator such that refrigerant at the evaporator outlet is always held at a temperature higher than the saturated vapor pressure curve of the refrigerant used in the refrigeration cycle, i.e. maintains a superheat level of SH. Therefore, the normally-charged type thermostatic expansion valve returns refrigerant delivered from the evaporator to the variable displacement compressor in a fully evaporated state, and hence has the characteristic that the refrigeration cycle using the same has an excellent coefficient of performance.

Although the two types of expansion valves are known as described above, in actuality, the cross-charged type thermostatic expansion valve is employed in refrigeration cycles using a variable displacement compressor. There are two reasons for this. One of the reasons is that the cross-charged type thermostatic expansion valve is insensitive to changes in the flow rate of refrigerant when the variable displacement compressor is performing small displacement operation, which makes it possible to prevent occurrence of hunting in the system of the refrigeration cycle. The other reason is that sufficient oil circulation is maintained by liquid returned to the compressor when it performs the small displacement operation, which makes it possible to avoid seizure of the compressor due to shortage of oil.

FIG. 7 shows changes in the power of the variable displacement compressor actually measured with respect to the cooling power of the refrigeration cycle, in the case where the cross-charged type thermostatic expansion valve is used in combination with the compressor and the case where the normally-charged type thermostatic expansion valve is used in combination with the same. In FIG. 7, each solid line shows changes in the power of the compressor when the cross-charged type thermostatic expansion valve is used in combination therewith, and each broken line shows changes in the power of the compressor when the normally-charged type thermostatic expansion valve is used in combination therewith. Further, FIG. 7 shows changes in the power of the compressor in association with changes in the cooling power caused by varying the flow rate, temperature, and humidity of air blown onto an evaporator to produce various states of the refrigeration cycle ranging from a low-load state to a high-load state, in respective cases where the compressor is operated at rotational speeds of 800 rpm, 1,800 rpm, and 2,500 rpm.

It is understood from FIG. 7 that when the rotational speed of the variable displacement compressor is high, in both of the cross-charged type and the normally-charged type, the change in power consumption is substantially proportional to that in the cooling power. On the other hand, if the compressor enter a variable displacement region when the rotational speed thereof is low e.g. during idling of the engine, the power consumption of the compressor used in combination with the cross-charged type thermostatic expansion valve remains almost unchanged even if the cooling power is changed, whereas that of the compressor used in combination with the normally-charged type thermostatic expansion valve changes substantially proportionally to the change in the cooling power. Further, in a region where the cooling load is low, the cross-charged type thermostatic expansion valve stops restricting the flow of refrigerant irrespective of the rotational speed, causing liquid refrigerant containing oil to return to the compressor, which inhibits reduction of the cooling power. On the other hand, the normally-charged type thermostatic expansion valve restricts the flow of refrigerant in the region where the cooling load is low, and hence power consumption is reduced in proportion to reduction in the cooling power. When the flow rate of refrigerant is small, however, the normally-charged type thermostatic expansion valve suffers from the problem of inevitably causing hunting of the system of the refrigeration cycle.

As described above, the cross-charged type thermostatic expansion valve has the characteristic that in the region where the cooling load is low, it stops the restriction of the refrigerant flow rate halfway to continue to be open. Therefore, this type of expansion valve meets both the requirement of securing a minimum flow rate for preventing hunting and the requirement of securing a minimum flow rate for oil circulation, at the same time. In view of this, the cross-charged type thermostatic expansion valve is used in combination with the variable displacement compressor.

It should be noted that since the present invention is based on known and publicly used techniques, prior art literature is not specifically disclosed.

However, in the case where the cross-charged type thermostatic expansion valve is used in combination with the variable displacement compressor, particularly when the rotational speed of the compressor is low, power consumption hardly changes even if the cooling load decreases. On the other hand, in the case where the normally-charged type thermostatic expansion valve is used in combination with the compressor, power consumption corresponding to the same level of cooling power is significantly lower in any rotational speed than in the case where the cross-charged type thermostatic expansion valve is used in combination with the compressor, but the combination of the variable displacement compressor and the normally-charged type thermostatic expansion valve cannot be employed due to the problems of hunting and oil circulation.

### SUMMARY OF THE INVENTION

The present invention has been made in view of the above described problems, and an object thereof is to provide a refrigeration cycle which is capable of reducing power consumption while solving the problems of hunting and oil circulation.

To solve the above problems, the present invention provides a refrigeration cycle including a variable displacement compressor, and an evaporator, comprising an expansion valve that is capable of controlling a flow rate of refrigerant supplied to the evaporator such that the refrigerant at an outlet of the evaporator maintains a predetermined level of superheat in normal times, and allowing the refrigerant to flow at a predetermined minimum flow rate when the flow rate is most restricted.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a system diagram showing a refrigeration cycle according to the present invention.

FIG. 2 is a central longitudinal cross-sectional view showing an example of a normally-charged type thermostatic expansion valve provided with a bypass passage.

FIG. 3 is a diagram showing how the power of a variable displacement compressor changes with cooling power when the variable displacement compressor rotates at 800 rpm.

FIG. 4 is a diagram showing how the power of the variable displacement compressor changes with the cooling power when the variable displacement compressor rotates at 1,800 rpm.

FIG. 5 is a diagram showing how the power of the variable displacement compressor changes with the cooling power when the variable displacement compressor rotates at 2,500 rpm.

FIG. 6 is a diagram showing characteristics of a thermostatic expansion valve.

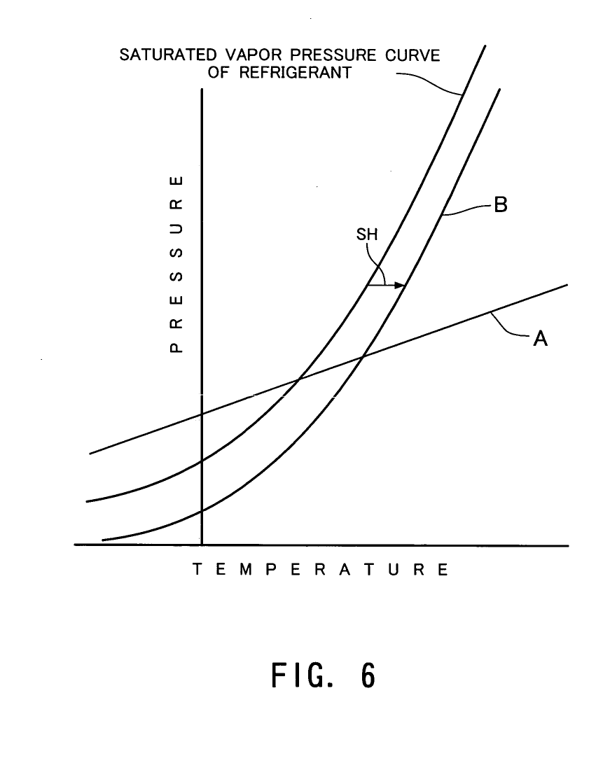

FIG. 7 is a diagram showing how the power of a variable displacement compressor changes with cooling power.

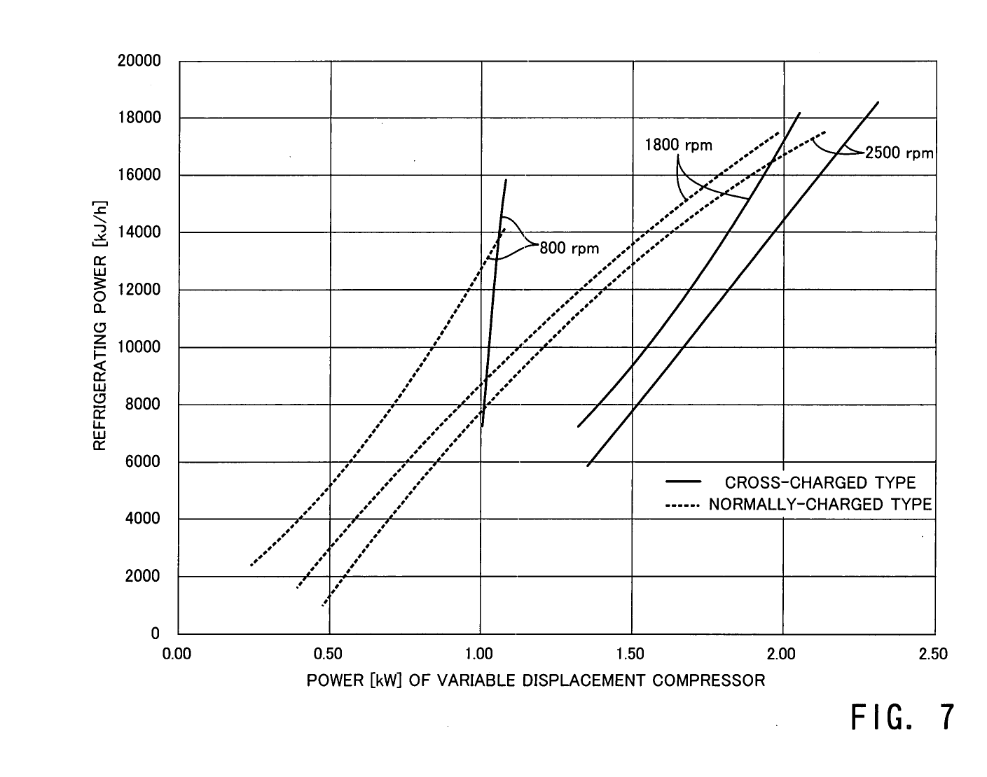

### DESCRIPTION OF THE PREFERRED EMBODIMENTS

Hereinafter, an embodiment of the present invention will be described in detail with reference to the drawings.

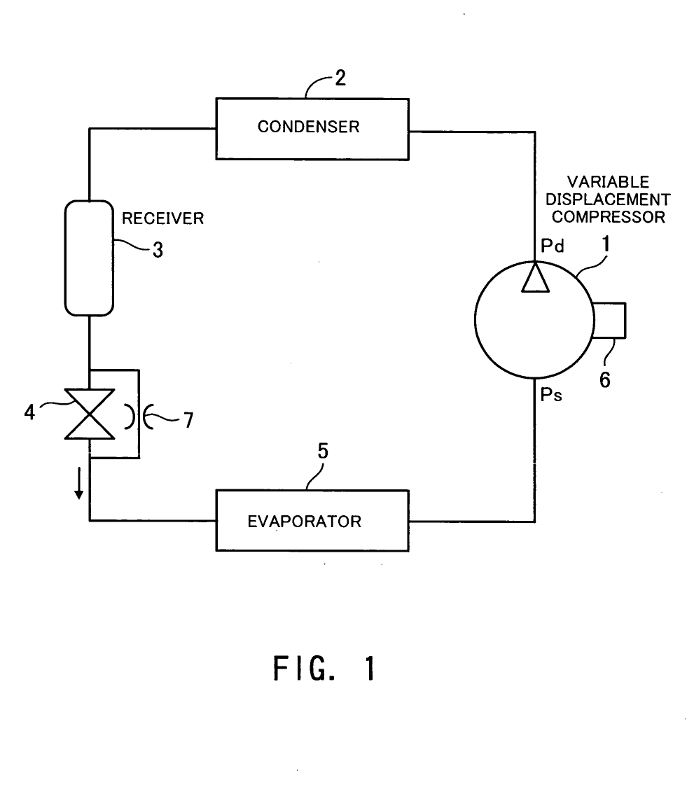

FIG. 1 is a system diagram showing a refrigeration cycle according to the present invention.

The refrigeration cycle comprises a variable displacement compressor 1 that compresses refrigerant, a condenser 2 that condenses the compressed refrigerant, a receiver 3 that separates the condensed refrigerant into vapor and liquid, an expansion valve 4 that performs throttling of the separated liquid refrigerant, and an evaporator 5 that evaporates the throttled refrigerant. The variable displacement compressor 1 is provided with a capacity control valve 6 that controls the volume of discharged refrigerant, i.e. displacement of the compressor, and the expansion valve 4 is provided with a minimum flow rate-securing means 7 for allowing the refrigerant to flow at a predetermined minimum flow rate even when the flow rate is most restricted.

The capacity control valve 6 that controls the refrigerant displacement of the variable displacement compressor 1 is implemented by either an internal control type whose set value cannot be changed or an external control type whose set value can be freely changed by an external electric signal. The internal control-type capacity control valve 6 can be a mechanical Ps control type that senses the suction pressure Ps of the variable displacement compressor 1, and controls pressure in a crankcase in response thereto such that the suction pressure Ps is held constant. On the other hand, the external control-type capacity control valve 6 can be a Ps control type capable of freely setting the suction pressure Ps of the variable displacement compressor, which is to be controlled to be constant, by the value of an electric current supplied to its solenoid, a Pd-Ps control type capable of freely setting the differential pressure between the discharge pressure Pd and the suction pressure Ps of the variable displacement compressor, which is to be controlled to be constant, by the value of an electric current supplied to its solenoid, or a flow rate control type capable of freely setting the flow rate of refrigerant to be discharged from the variable displacement compressor, which is to be controlled to be constant.

The expansion valve 4 for combination with the variable displacement compressor 1 of each of the various control types described above can be implemented by a thermostatic expansion valve of the normally-charged type including the minimum flow rate-securing means 7 or a solenoid-driven electronic expansion valve provided with the function of the minimum flow rate-securing means 7. For example, in the case of the thermostatic expansion valve, the minimum flow rate-securing means 7 can be implemented by a bypass passage that is formed in a valve section so as to allow the refrigerant to continue to flow at a predetermined flow rate via the bypass passage even when a valve element is seated on the associated valve seat. In the case of the electronic expansion valve, the function of the minimum flow rate-securing means 7 can be realized by preventing the valve element from being fully closed e.g. by bringing the valve element into contact with a stopper immediately before the valve element is seated on the valve seat.

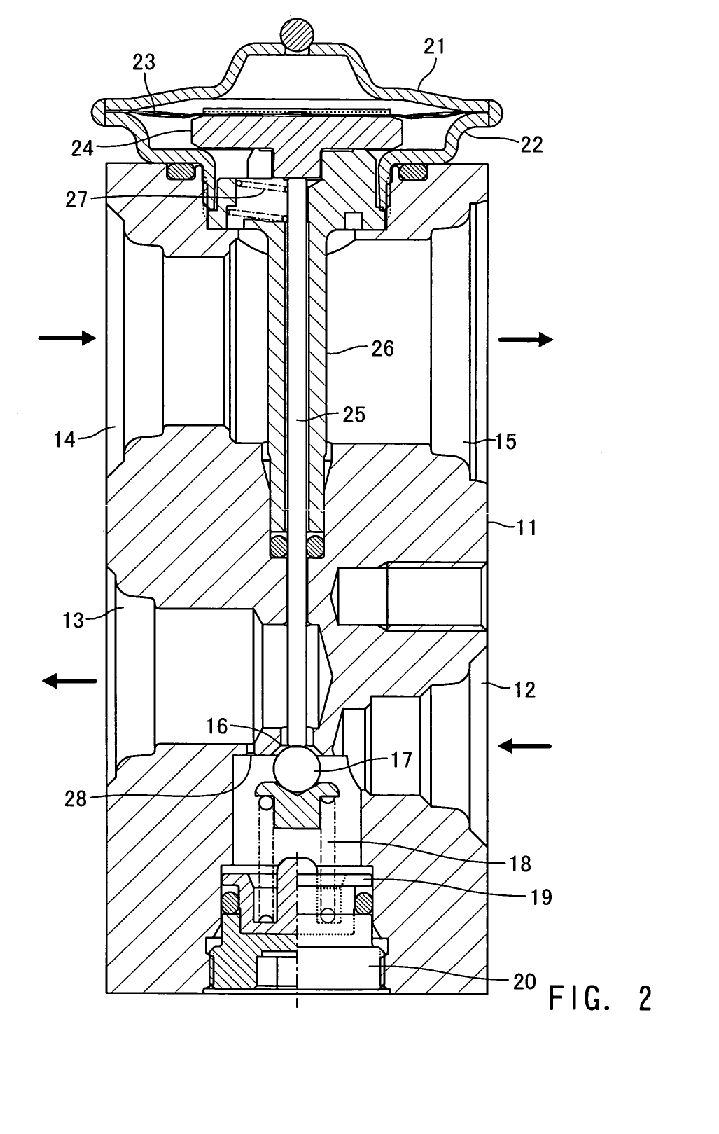

FIG. 2 is a central longitudinal cross-sectional view showing an example of the normally-charged type thermostatic expansion valve having the bypass passage formed therein.

The thermostatic expansion valve has a body 11 having a side wall formed with a port 12 via which high-temperature, high-pressure liquid refrigerant is received, a port 13 via which low-temperature, low-pressure refrigerant throttled by the thermostatic expansion valve is supplied to the evaporator 5, a port 14 via which evaporated refrigerant is received from the evaporator 5, and a port 15 via which refrigerant having passed through the thermostatic expansion valve is returned to the variable displacement compressor 1.

A valve seat 16 is integrally formed with the body 11 in a fluid passage that communicates between the port 12 and the port 13, and a ball-shaped valve element 17 is provided at a location upstream of the valve seat 16. In a space accommodating the valve element 17, there is disposed a helical compression spring 18 for urging the valve element 17 in the direction of seating the same on the valve seat 16. The helical compression spring 18 is received by a spring receiver 19. The spring receiver 19 is fitted in an adjustment screw 20 screwed into the lower end of the body 11 such that the load of the helical compression spring 18 can be adjusted by adjusting the amount of screwing of the adjustment screw 20 into the body 11.

Further, at the top end of the body 11 of the thermostatic expansion valve, as viewed in FIG. 2, there is provided a power element which comprises an upper housing 21, a lower housing 22, a diaphragm 23 disposed in a manner dividing a space enclosed by the housings 21 and 22, and a disk 24 disposed below the diaphragm 23. A temperature-sensing tube hermetically enclosed by the upper housing 21 and the diaphragm 23 is filled with the same refrigerant as used in the refrigeration cycle, whereby the thermostatic expansion valve is configured as the normally-charged type.

Below the disk 24, there is disposed a shaft 25 for transmitting displacement of the diaphragm 23 to the valve element 17. The upper end of the shaft 25 is held by a holder 26 disposed in a manner extending across the fluid passage communicating between the ports 14 and 15. The holder 26 has a helical compression spring 27 provided therein for giving lateral load to the upper end of the shaft 25, such that the helical compression spring 27 suppresses longitudinal vibration of the shaft 25 which occurs in response to pressure fluctuation of the high-pressure refrigerant.

Further, at a location close to the valve seat 16, the body 11 is formed with a bypass passage 28 that bypasses a valve section. The bypass passage 28 is provided so as to allow the refrigerant to flow at a sufficient flow rate for securing oil circulation, without causing hunting between the control of the expansion valve and that of the variable displacement compressor 1, even when the valve section is fully closed.

In the thermostatic expansion valve configured as above, the power element senses the pressure and temperature of the refrigerant returned from the evaporator 5 to the port 14, and controls the valve lift of the thermostatic expansion valve by pushing the valve element 17 in the valve-opening direction when the refrigerant temperature is high or the refrigerant pressure is low, and moving the valve element 17 in the valve-closing direction when the refrigerant temperature is low or the refrigerant pressure is high. On the other hand, the liquid refrigerant supplied from the receiver 3 flows through the port 12 into the space accommodating the valve element 17, and is throttled by passage thereof through the valve section having its valve lift controlled, thereby being changed into low-temperature, low-pressure refrigerant. The refrigerant flows out from the port 13 and is supplied to the evaporator 5, where the refrigerant is subjected to heat exchange with air in a vehicle compartment and then returned to the port 14. At this time, the thermostatic expansion valve controls the flow rate of the refrigerant supplied to the evaporator 5 such that the refrigerant at the outlet of the evaporator 5 maintains a predetermined level of superheat, so that refrigerant is returned in a completely evaporated state from the evaporator 5 to the variable displacement compressor 1. Further, when the thermostatic expansion valve progressively restricts the refrigerant flow rate due to decrease in the cooling load until the valve element 17 is seated on the valve seat 17, the valve section is placed in a fully-closed state, but since the bypass passage 28 is provided, the refrigerant is allowed to flow through the bypass passage 28 at the predetermined minimum flow rate required for prevention of hunting and maintenance of oil circulation.

It should be noted that although in the thermostatic expansion valve of the present example, the bypass passage 28 is implemented by an orifice formed in the body 11 at a location close to the valve seat 16 such that the orifice bypasses the valve section, this is not limitative, but it may be, for example, in the form of a groove formed in the seating surface of the valve seat 16 such that the groove extends in the direction of the refrigerant flow, so as to allow the refrigerant to flow along the groove at the minimum flow rate even after the valve element 17 is seated on the valve seat 16, or in the form of an orifice or a slit formed in the valve element 17 so as to allow the refrigerant to flow through the orifice or the slit at the minimum flow rate when the valve is fully-closed.

Next, a description will be given of preferred examples of combination between types of the variable displacement compressor 1 and types of the expansion valve 4. As described hereinbefore, the variable displacement compressor 1 includes the internal control-based Ps control type, the external control-based Ps control type, the external control-based Pd-Ps control type, and the external control-based flow rate control type, and the expansion valve 4 includes the normally-charged type thermostatic expansion valve having the bypass passage 28 formed therein or the external control-based electronic expansion valve.

### EXAMPLE 1

Combination of the variable displacement compressor 1 of the internal control-based or external control-based Ps control type and the normally-charged type thermostatic expansion valve having the bypass passage 28:

In this combination, when the cooling load is low, the flow rate of refrigerant can be more reduced than in the case where the cross-charged type thermostatic expansion valve is employed, and therefore the present combination is advantageous in that the power consumption of the variable displacement compressor 1 can be reduced. However, when the bypass amount is excessively reduced, hunting tends to occur between the control of the variable displacement compressor 1 of the Ps control type and that of the expansion valve 4. In general, if the refrigerant is allowed to flow at a flow rate of approximately 80 kg/h, it is possible to prevent occurrence of the hunting, so that the bypass passage 28 should be formed by an orifice with a diameter of approximately 0.7 mm to 1.2 mm, and more preferably by an orifice with a diameter of approximately 1.0 mm.

### EXAMPLE 2

Combination of the variable displacement compressor 1 of the external control-based Pd-Ps control type and the normally-charged type thermostatic expansion valve having the bypass passage 28:

In this combination, when the cooling load is low, the flow rate of refrigerant can be more reduced than in the case where the cross-charged type thermostatic expansion valve is employed, and therefore the present combination is advantageous in that the power consumption of the variable displacement compressor 1 can be reduced. In this case, differently from the Ps control type, the Pd-Ps control-type variable displacement compressor 1 does not cause hunting between the control thereof and the control of the expansion valve 4 even when the bypass amount is reduced, so that the bypass passage 28 can be formed by a passage having the minimum size required for oil circulation, which makes it possible to further reduce the power consumption of the variable displacement compressor 1. In general, the minimum flow rate required for oil circulation is approximately 50 kg/h, and hence it is preferred that the bypass passage 28 is formed by an orifice with a diameter of approximately 0.5 mm. It should be noted that also when the variable displacement compressor 1 is the external control-based flow rate control type, it is preferable that the bypass passage 28 is similarly formed by an orifice with a diameter of approximately 0.5 mm.

### EXAMPLE 3

Combination of the variable displacement compressor 1 of the internal control-based or external control-based Ps control type and the external control-based electronic expansion valve that can be controlled such that it is not closed:

Differently from the case where the expansion valve 4 is implemented by the normally-charged type thermostatic expansion valve having the bypass passage 28, which tends to cause hunting when the refrigerant flow rate is small, in the present combination, the electronic expansion valve can be formed e.g. by a flow rate control-type solenoid valve that enables control of the flow rate of refrigerant by an external signal, so that the electronic expansion valve can be controlled such that hunting is prevented from occurring when the refrigerant flow rate is small, which makes it possible to reduce the power consumption of the variable displacement compressor 1.

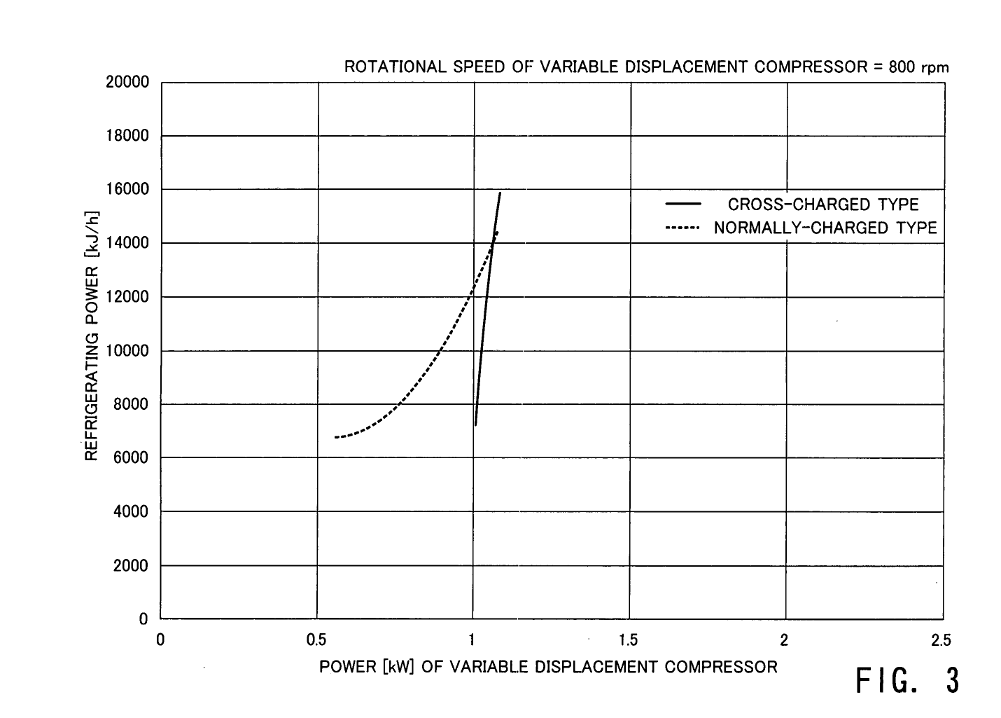

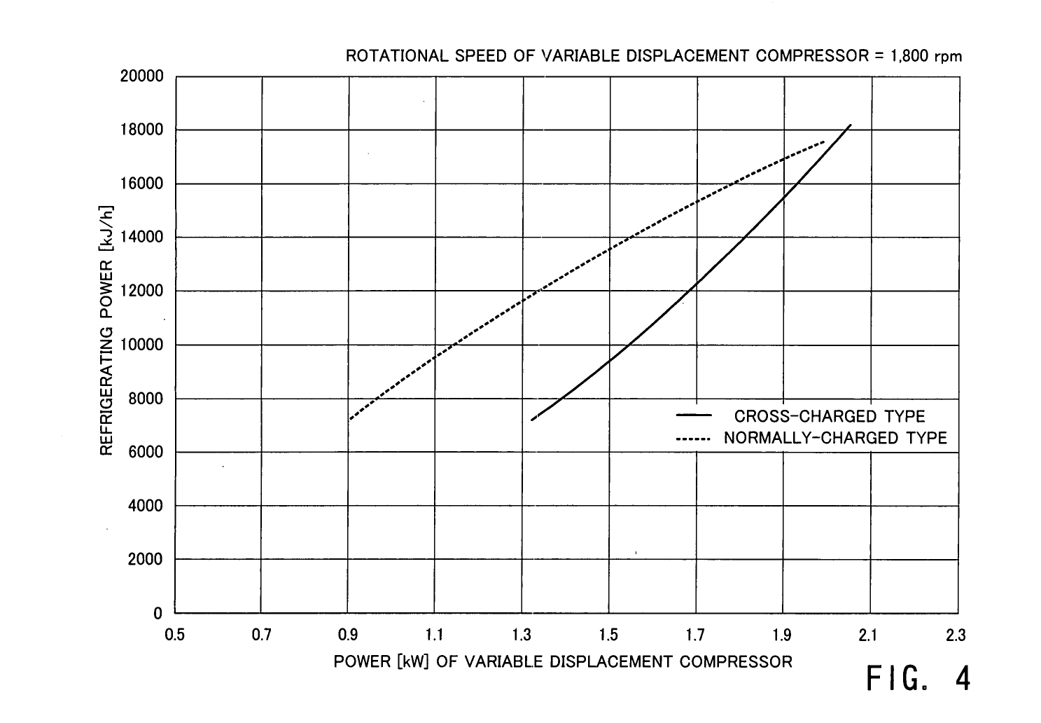

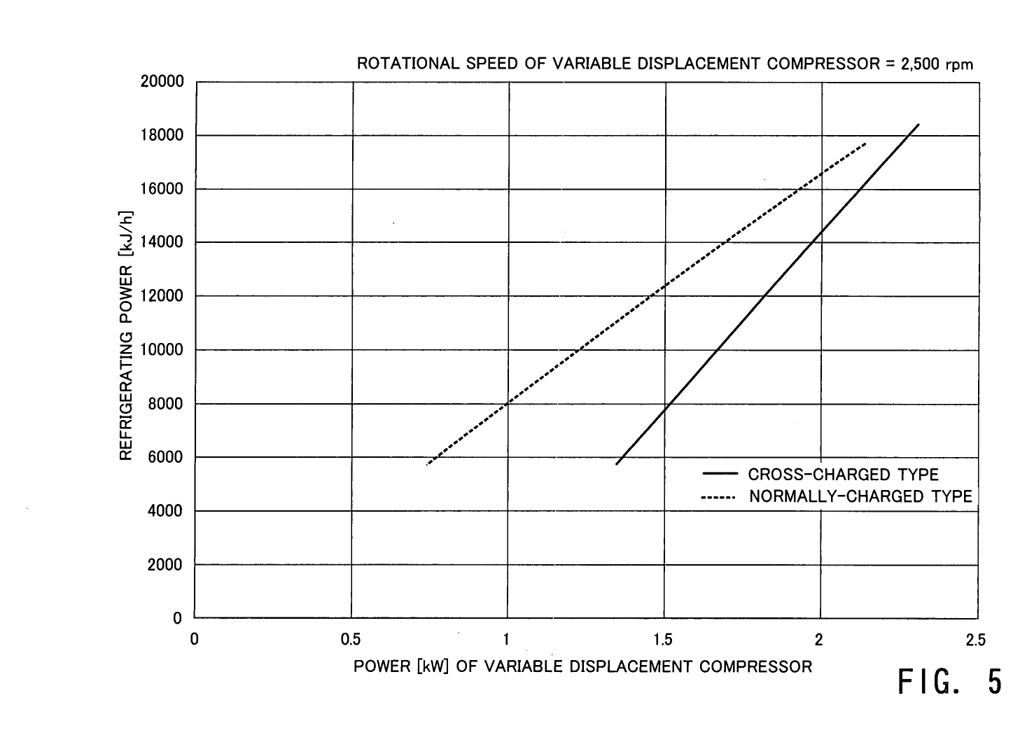

FIG. 3 is a diagram showing how the power of the variable displacement compressor 1 changes with the cooling power when the variable displacement compressor rotates at 800 rpm, FIG. 4 is a diagram showing how the power of the variable displacement compressor 1 changes with the cooling power when the variable displacement compressor rotates at 1,800 rpm, and FIG. 5 is a diagram showing how the power of the variable displacement compressor 1 changes with the cooling power when the variable displacement compressor rotates at 2,500 rpm.

As is apparent from FIGS. 3 to 5, in the case of the refrigeration cycle equipped with the variable displacement compressor 1 and the expansion valve 4 capable of allowing refrigerant to flow at a predetermined minimum flow rate even when the flow rate is most restricted, in all of the rotational speeds of 800 rpm, 1,800 rpm, and 2,500 rpm, when the variable displacement compressor 1 is in a variable displacement region due to low cooling load, power consumption corresponding to the same cooling power level is improved by approximately 30% than in the case where the combination of the variable displacement compressor and the cross-charged type thermostatic expansion valve is employed. It should be noted that in the characteristics of the normally-charged type thermostatic expansion valve, power consumption is also reduced in proportion to the decrease in the cooling power, by virtue of the use of the normally-charged type thermostatic expansion valve, and the lower limit value of the cooling power is similar to that in the characteristics of the cross-charged type thermostatic expansion valve, by virtue of the provision of the bypass passage 28 in the expansion valve 4.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. A refrigeration cycle including a variable displacement compressor, and an evaporator, comprising:
an expansion valve that is capable of controlling a flow rate of refrigerant supplied to the evaporator such that the refrigerant at an outlet of the evaporator maintains a predetermined level of superheat in normal times, and allowing the refrigerant to flow at a predetermined minimum flow rate when the flow rate is most restricted.

2. The refrigeration cycle according to claim 1, wherein the variable displacement compressor senses suction pressure, and controls pressure in a crankcase in response to the sensed suction pressure such that the suction pressure is held constant, and
wherein the expansion valve is a thermostatic expansion valve of a normally-charged type that has a valve section formed with a bypass passage.

3. The refrigeration cycle according to claim 2, wherein the bypass passage has a size large enough to allow the refrigerant to flow at a flow rate required at least for preventing hunting.

4. The refrigeration cycle according to claim 1, wherein the variable displacement compressor senses differential pressure between discharge pressure and suction pressure, and controls pressure in a crankcase in response to the sensed differential pressure such that the differential pressure is held constant, and
wherein the expansion valve is a thermostatic expansion valve of a normally-charged type that has a valve section formed with a bypass passage.

5. The refrigeration cycle according to claim 4, wherein the bypass passage has a size large enough to allow the refrigerant to flow at a minimum flow rate required at least for oil circulation.

6. The refrigeration cycle according to claim 1, wherein the variable displacement compressor senses suction pressure and controls pressure in a crankcase in response to the sensed suction pressure such that the suction pressure is held constant, and
wherein the expansion valve is a solenoid-driven electronic expansion valve that can be controlled such that the solenoid-driven electronic expansion valve is not closed.
